(19) United States
(12) Patent Application Publication
(10) Pub. No.: US 2010/0031627 A1
(43) Pub. Date: Feb. 11, 2010

(54) Heater Assemblies, Gas Turbine Engine Systems Involving Such Heater Assemblies and Methods for Manufacturing Such Heater Assemblies

(75) Inventor: John H. Vontell, Manchester, CT (US)

Correspondence Address: CARLSON, GASKEY & OLDS/PRATT & WHITNEY, 400 WEST MAPLE ROAD, SUITE 350, BIRMINGHAM, MI, 48009, US

(73) Assignee: UNITED TECHNOLOGIES CORP., Hartford, CT (US)

(21) Appl. No.: 12/187,839

(22) Filed: Aug. 7, 2008

(51) Int. Cl. F02K 3/02; B23P 11/00; H05B 3/06

(52) U.S. Cl. 60/226.1; 29/428; 219/521

(57) ABSTRACT

Heater assemblies, gas turbine engine systems involving such heater assemblies and methods for manufacturing such heater assemblies are provided. In this regard, a representative method includes: providing a substrate; forming a heating element using a thermal sprayed metal process such that the metal heater comprises an aggregation of sprayed metal particles; attaching the heating element to the substrate; and consolidating at least some of the metal particles located at an exterior of the heating element to form an electrical contact pad of the heating element.

### STATEMENT REGARDING FEDERALLY SPONSORED RESEARCH AND DEVELOPMENT

The U.S. Government may have an interest in the subject matter of this disclosure as provided for by the terms of contract number N0019-020C-3003 awarded by the United States Navy.

### BACKGROUND

1. Technical Field

The disclosure generally relates to gas turbine engines.

2. Description of the Related Art

A gas turbine engine typically includes an annular gas path that generally extends between an inlet and an exhaust. The structure used to define the gas path is oftentimes supported by struts that extend across the gas path, with corresponding ends of the struts typically supporting one or more rotating shafts of the engine and the opposing ends supporting an engine casing. In some engines, provisions for reducing accumulation of ice are incorporated into the struts, particularly inlet struts.

### SUMMARY

Heater assemblies, gas turbine engine systems involving such heater assemblies and methods for manufacturing such heater assemblies are provided. In this regard, an exemplary embodiment of a method for manufacturing a heater assembly for a gas turbine engine comprises: providing a substrate; forming a heating element using a thermal sprayed metal process such that the heating element comprises an aggregation of sprayed metal particles; attaching the heating element to the substrate; and consolidating at least some of the metal particles located at an exterior of the heating element to form an electrical contact pad of the heating element.

An exemplary embodiment of a heater assembly for a gas turbine engine comprises: a substrate; and a heating element supported by the substrate and having a base and an electrical contact pad, the base comprising aggregated sprayed metal particles, the electrical contact pad comprising consolidated ones of the metal particles located at an exterior of the heating element.

An exemplary embodiment of a gas turbine engine comprises: a gas turbine engine casing defining a gas flow path; and a strut extending across at least a portion of the gas flow path, the strut having a heater assembly, the heater assembly comprising: a substrate; and a heating element supported by the substrate, the heating element having a base and an electrical contact pad, the base comprising aggregated sprayed metal particles, the electrical contact pad comprising consolidated ones of the metal particles located at an exterior of the heating element.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale. Moreover, in the drawings, like reference numerals designate corresponding parts throughout the several views.

FIG. 1 is a schematic diagram depicting an exemplary embodiment of a gas turbine engine.

FIG. 2 is a partially cut-away, cross-sectional diagram depicting a representative strut of FIG. 1, as viewed along section line 2-2.

FIGS. 3-5 are schematic diagrams depicting representative process steps involved in forming an exemplary embodiment of a heater assembly.

FIG. 6 is a schematic diagram depicting an exemplary embodiment of a heater assembly.

### DETAILED DESCRIPTION

Heater assemblies, gas turbine engine systems involving such heater assemblies and methods for manufacturing such heater assemblies are provided, several exemplary embodiments of which will be described in detail. In this regard, heater assemblies can be used to provide anti-icing and/or de-icing provisioning of inlet struts, for example. In some embodiments, the heater assemblies include heating elements formed of thermal sprayed metal, which provides an aggregation of metal particles. As such, the heating elements present a generally porous structure, which can be problematic when attempting to attach electrical connectors to the heating elements. Specifically, when attempting to solder wire to the porous structure, solder can flow into the voids located between the metal particles, thereby tending to increase the stiffness of the heating elements. In cases in which flexibility is desirable, such as when the heating elements are to conform to a deflectable substrate, an increase in stiffness can result in increased stresses at the heating element-substrate interface. Additionally, the solder and solder flux can interfere directly with bonding between the heating element and the substrate, such as by wicking flux into the porous metal heater.

In some embodiments, a portion of the aggregation of metal particles of a heating element is consolidated to provide an electrical contact pad for facilitating electrical connection. By way of example, a laser can be used to melt a desired area and depth of the metal particles to form such a pad. In this manner, electrical connection can be made with the consolidated metal particles while limiting the ability of solder and solder flux to interfere with bonding between the heating element and the substrate. Additionally, the consolidated surface allows electrical connection using resistance welding techniques, in some embodiments, eliminating the need for soldering flux.

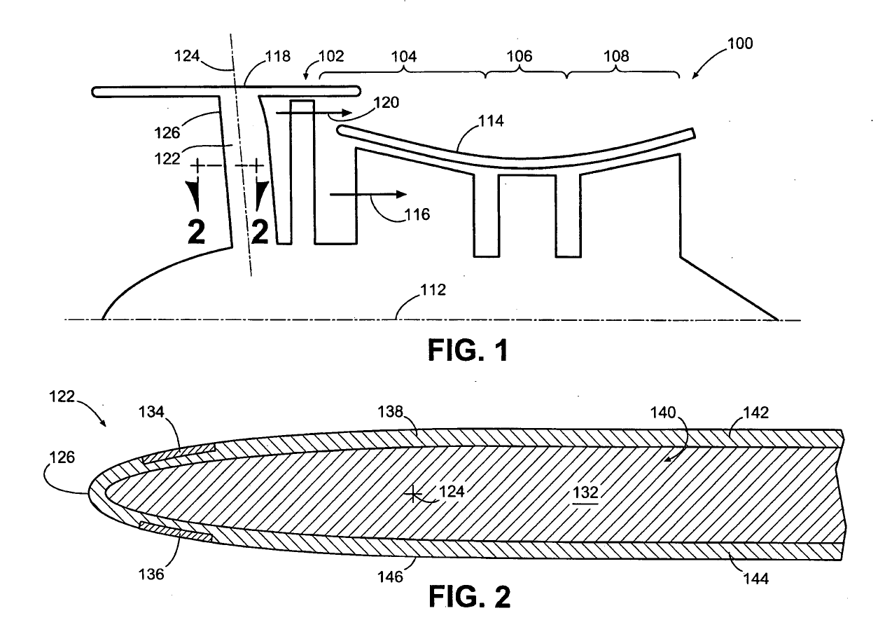

In this regard, reference is made to the schematic diagram of FIG. 1, which depicts an exemplary embodiment of a gas turbine engine. As shown in FIG. 1, engine 100 is depicted as a turbofan that incorporates a fan 102, a compressor section 104, a combustion section 106 and a turbine section 108 that extend along an axis 112. Although depicted as a turbofan gas turbine engine, it should be understood that the concepts described herein are not limited to use with turbofans as the teachings may be applied to other types of gas turbine engines.

Generally, compressor section 104, combustion section 106 and turbine section 108 (in cooperation with an engine case 114) define a gas flow path 116. Additionally, a fan case 118, which is displaced radially outward from the engine case, serves to define a fan gas flow path 120. Struts (e.g., inlet strut 122) are positioned circumferentially about axis 112 and extend radially to support the fan case 118. Notably, a longitudinal axis 124 of strut 122 is depicted that is generally parallel to leading edge 126.

Strut 122 is depicted in greater detail in the cross-sectional diagram of FIG. 2. As shown in FIG. 2, strut 122 includes an inner strut 132, heating assembly 131 (which includes heating elements 134, 136) and an exterior sheath 138. The inner strut, which is depicted schematically, provides structural support for the strut in this embodiment and fills virtually the entirety of the inner cavity 140 formed by opposing sides 142, 144 of sheath 138. However, in other embodiments, various other shapes of inner struts can be used.

Sheath 138 is secured to the inner strut, with the exterior surface 146 of the sheath defining a portion of the gas flow path of engine 100. Various materials can be used to form an exterior sheath. By way of example, polymer matrix composite with reinforcement materials (such as carbon, glass or aramid) in unidirectional tape or fabric forms with resin matrix (such as epoxy, polyimide, bismaleimide, or pthalonitrile) or similar materials can be used. In the embodiment of FIGS. 1 and 2, structural fiberglass reinforced bismaleimide matrix composite is used to form sheath 138 and silicone is used to adhere the sheath to inner strut 132.

Notably, strut 122 is an inlet strut and, therefore, may experience icing conditions. In this regard, heater elements 134, 136 are located near the outer surface of sheath 138 in a vicinity of leading edge 126 in order to add a degree of anti-icing and/or deicing protection. Additional heater elements may be used to provide a larger area of protection in other embodiments. In operation, the heating elements are controlled to resistively heat, thereby increasing the temperature of the exterior of the sheath adjacent to the heating elements. The thermal profile can be controlled to either prevent ice formation (anti-icing) or allow accumulation of ice followed by ice shedding (de-icing).

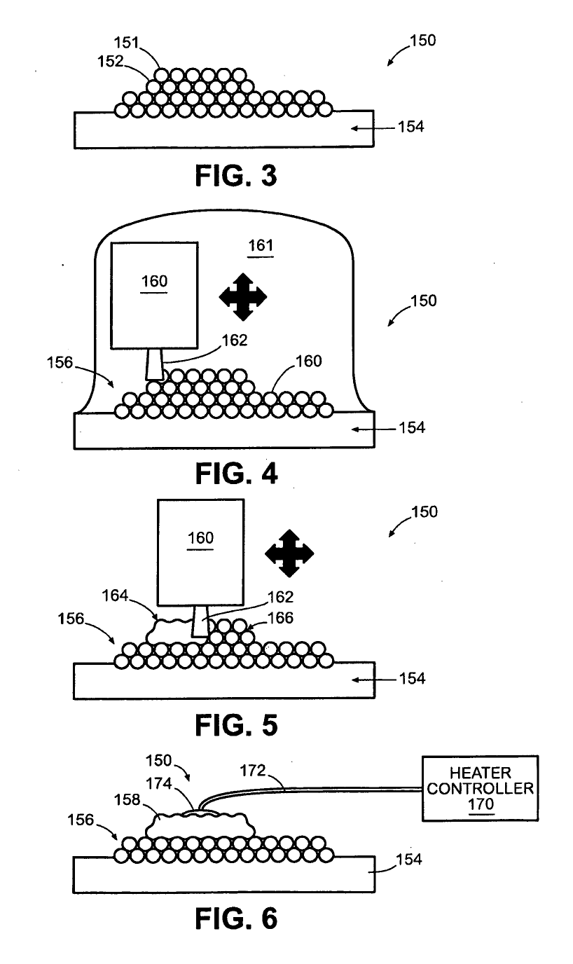

FIGS. 3-5 are schematic diagrams depicting representative process steps involved in forming an exemplary embodiment of a heater assembly. As shown in FIG. 3, heater assembly 150 is formed with a thermal sprayed metal in the form of solidified metal particles (e.g., particles 151, 152), which are applied to a substrate 154. In this embodiment, the substrate is fiberglass fabric although other substrate materials (i.e., materials that are electrical insulators, such as aluminum oxide) can be used in other embodiments. The thermal sprayed metal, which in this embodiment is a copper alloy, is applied to form a heating element 156 using a flame spray technique (e.g., a flame spray technique used by GKN Aerospace).

In other embodiments, various other thermal spray techniques can be used. Additionally, in other embodiments, various other metals and/or metal alloys can be used for forming the heating element. By way of example, metals and/or metal alloys that exhibit electrical resistivity properties that result in heating such as titanium, titanium alloys, nickel alloys and aluminum alloys can be used.

An electrical contact pad 158 is formed on an exterior surface 160 of the heating element. In this embodiment, pad 158 is formed of a different material than that of heating element 156. Specifically, pad 158 is formed of copper although various other materials can be used in other embodiments. Pad 158 also is formed by thermal sprayed metal.

As mentioned previously, the porous nature of thermal sprayed metal in this implementation tends to make electrical connection to the heating element problematic. As shown in FIGS. 4 and 5, however, some of the perceived difficulty may be alleviated by consolidating the surface of the thermal sprayed metal of the pad. In particular, the embodiment of FIG. 4 depicts a laser 160 positioned within a controlled atmosphere 161. The controlled atmosphere (e.g., Argon) is provided to reduce the potential for forming undesirable oxides during a melting procedure of the thermal sprayed metal. In other embodiments, the atmosphere can be modified to promote chemical interaction with the melting metal of the pad.

As shown in FIG. 5, laser 160 is controlled (such as by rastering the laser as indicated by the arrows) to illuminate selected portions of the thermal sprayed metal in order to melt and consolidate a pre-selected area and depth of the metal particles. In some embodiments, laser beam 162 emitted by the laser is generally unfocused to enhance melting and depth penetration by reducing the energy-to-area ratio. In FIG. 5, portion 164 has been consolidated to form a contiguous, substantially void-free mass of metal. This is in contrast to portion 166, which is yet to be consolidated, and which includes substantial voids between the metal particles. Alternative methods for applying the thermal energy for melting include, but are not limited to, an electrically heated jet of hot gas (such as nitrogen) or a high temperature flame (such as the type achieved by burning oxygen and acetylene).

As shown in FIG. 6, consolidation of the material of pad 158 is completed and a heater controller 170 is electrically connected to the heating element 156. In this embodiment, an electrical conductor 172 is electrically connected between the heater controller 170 and pad 158 using solder 174 and solder flux. Notably, the solder and solder flux are confined to the consolidated metal of the pad and have not adversely affected the structural integrity of the heating element as could occur if the solder were to contact substrate 154 during application. The consolidated surface prevents the solder flux wicking into the porous metal allowing removal before any bonding procedures are performed. Alternatively, the electrical conductor 172 can be electrically connected between the heater controller 170 and pad 158 using electrical resistance welding or techniques in other embodiments. In operation, the heater controller 170 provides electrical power to the heating element in order to initiate resistive heating of the heating element.

Incorporation of the heating element into a component (e.g., an exterior sheath) can be accomplished in a variety of manners. By way of example, a heater formed of a fiberglass substrate, a thermal sprayed element and laser consolidated pads may be suitable for being resin transfer molded into the component. The pad area would then be exposed and the soldering or welding operations performed to connect the electrical conductors.

It should be emphasized that the above-described embodiments are merely possible examples of implementations set forth for a clear understanding of the principles of this disclosure. Many variations and modifications may be made to the above-described embodiments without departing substantially from the spirit and principles of the disclosure. All such modifications and variations are intended to be included herein within the scope of this disclosure and protected by the accompanying claims.

1. A method for manufacturing a heater assembly for a gas turbine engine comprising:
providing a substrate;
forming a heating element using a thermal sprayed metal process such that the heating element comprises an aggregation of sprayed metal particles;
attaching the heating element to the substrate; and
consolidating at least some of the metal particles located at an exterior of the heating element to form an electrical contact pad of the heating element.

2. The method of claim 1, wherein consolidating the metal particles is performed after attaching the heating element to the substrate.

3. The method of claim 1, wherein consolidating the metal particles comprises melting the metal particles using a laser.

4. The method of claim 1, wherein consolidating the metal particles comprises melting the metal particles in a reduced oxygen atmosphere.

5. The method of claim 1, wherein consolidating the metal particles comprises melting the metal particles in a predetermined gaseous atmosphere such that a desired chemical composition of the electrical contact pad is formed during the melting.

6. The method of claim 1, wherein the electrical contact pad comprises copper.

7. The method of claim 1, further comprising electrically connecting a wire to the electrical contact pad.

8. The method of claim 7, wherein electrically connecting the wire comprises soldering the wire to the electrical contact pad.

9. The method of claim 1, wherein the substrate comprises fiberglass.

10. The method of claim 1, further comprising using the heater assembly as a portion of a strut for a gas turbine engine.

11. The method of claim 1, wherein attaching the heating element to the substrate comprises using a resin transfer molding process.

12. A heater assembly for a gas turbine engine comprising:
a substrate; and
a heating element supported by the substrate and having a base and an electrical contact pad, the base comprising aggregated sprayed metal particles, the electrical contact pad comprising consolidated ones of the metal particles located at an exterior of the heating element.

13. The heater assembly of claim 12, further comprising a wire electrically connected to the electrical contact pad.

14. The heater assembly of claim 13, wherein:
the heater assembly further comprises a heater controller operative to control heating of the heating element; and
the wire electrically interconnects the electrical contact pad and the heater controller.

15. The heater assembly of claim 13, wherein the wire is soldered to the electrical contact pad with solder.

16. The heater assembly of claim 15, wherein the solder is confined to the electrical contact pad such that the solder does not occupy voids located between unconsolidated ones of the metal particles.

17. The heater assembly of claim 12, wherein:
the substrate comprises fiberglass; and
the heating element is attached to the substrate with resin.

18. A gas turbine engine comprising:
a gas turbine engine casing defining a gas flow path; and
a strut extending across at least a portion of the gas flow path, the strut having a heater assembly, the heater assembly comprising:
a substrate; and
a heating element supported by the substrate, the heating element having a base and an electrical contact pad, the base comprising aggregated sprayed metal particles, the electrical contact pad comprising consolidated ones of the metal particles located at an exterior of the heating element.

19. The engine of claim 18, wherein the strut is an inlet strut.

20. The engine of claim 18, wherein the engine is a turbofan gas turbine engine.
